(19) United States
(12) Patent Application Publication
(10) Pub. No.: US 2004/0012950 A1
(43) Pub. Date: Jan. 22, 2004

(54) Decorative lamp-tree

(76) Inventor: Wun Fang Pan, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/195,538

(22) Filed: Jul. 16, 2002

(51) Int. Cl. F21W 121/04

(52) U.S. Cl. 362/123

(57) ABSTRACT

The present invention relates to a decorative lamp-tree, which includes a pine-like structure without leaves. A decorative light bulb string with several branch strings and extended strings is winded around on relative branches and tails on the lamp-tree. The well-distributed bulb on the tree provides a novel and perfect decoration.

### BACKGROUND OF THE INVENTION

A conventional Christmas tree, such as a pine, is usually used for decoration, which includes a trunk, many branches, and leaves while a light bulb string is winded around. To wind the known straight light bulb string on the tree is very inconvenience and the bulbs will be confused and disordered in the tree that ruins the decorative effect.

Accordingly, the primary object of the invention is to provide a decorative lamp-tree, which includes a trunk having many branches without a left for hanging with a special light bulb string. Now the features and advantages of the present invention will be described in detail with reference to the accompanying drawings.

### BRIEF DESCRIPTION OF ACCOMPANYING DRAWINGS

FIG. 1 is a plan view showing a decorative light bulb string according to the present invention.

FIG. 2 is a plan view showing a decorative lamp-tree hanging with the light bulb string of FIG. 1.

FIGS. 3 and 4 show a perspective view of one embodiment of a connector used in the present invention.

### DETAILED DESCRIPTION OF PREFERRED EMBODIMENTS

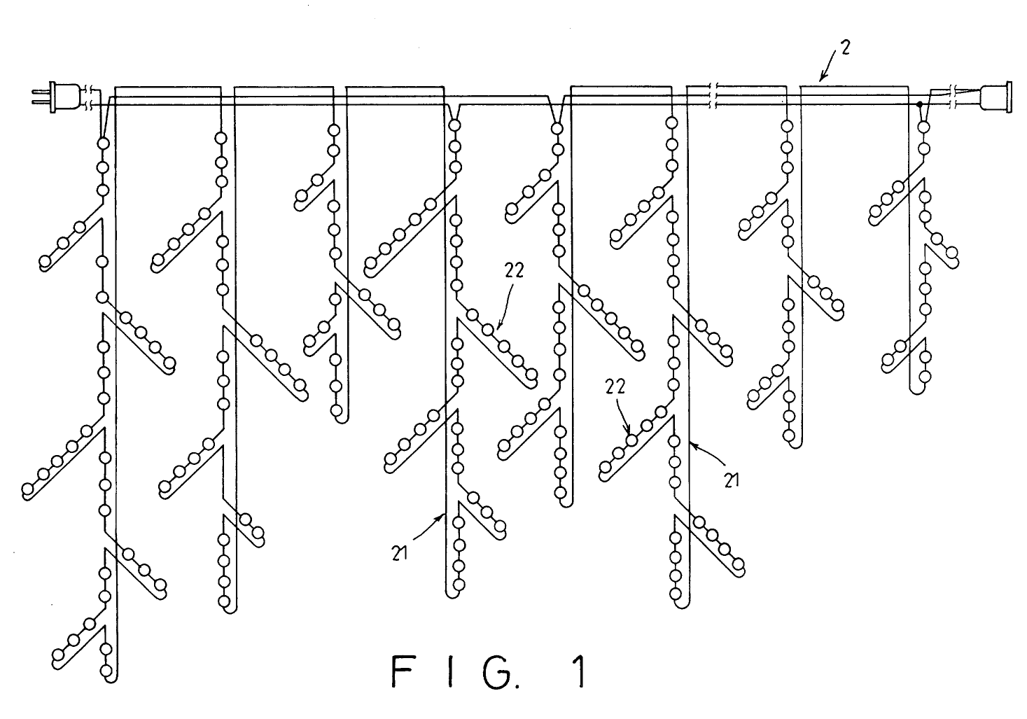

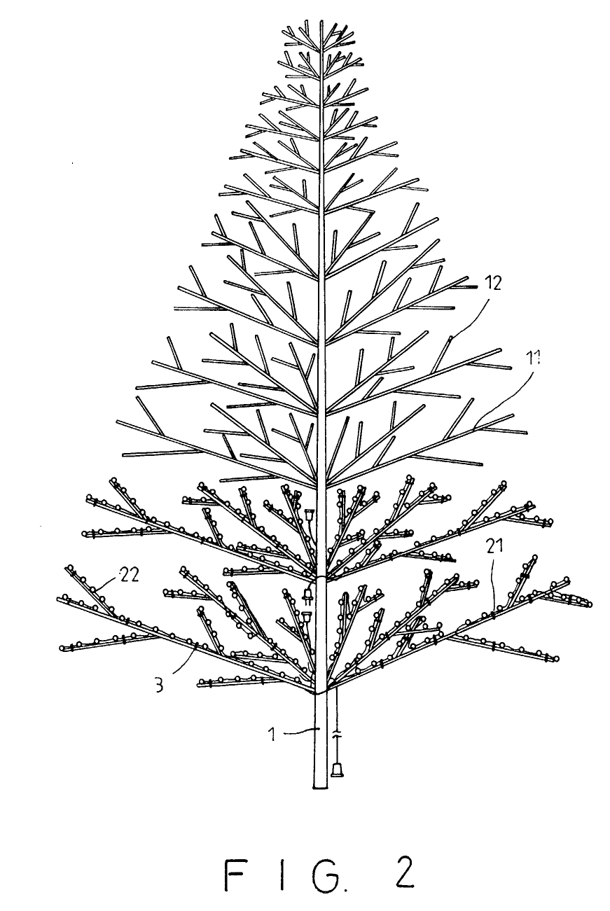

Please refer to FIGS. 1 and 2, the present invention mainly provides a lamp-tree structure, which includes a pine-like assembly and a decorative light bulb string (2). The pine-like assembly is composed of a trunk (1), many branches (11) connected with the trunk (1), and many tails (12) connected with each of the branch (11). The light bulb string (2) includes several branch strings (21) and several extended strings (22) connected with each of the branch string (21). Hence, when the light bulb string (2) is winded around the lamp-tree, a branch string (21) can be relatively winded on a branch (11) and each extended string (22) can be winded around a tail (12) of the branch (11).

It is known that the present invention uses a special light bulb string for winding around a relative branch or a tail that forms a perfect lamp-tree to show every bulb well distributed. This obtains a better decorative effect than ever.

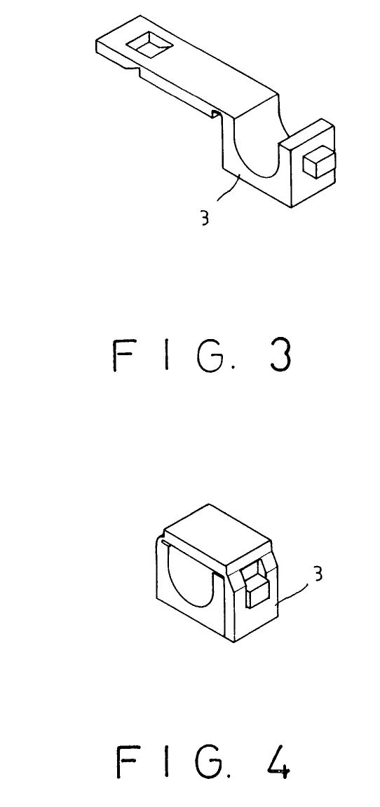

As shown in FIGS. 3 and 4, a connector (3) can be used for engaging the string (2) on the branch (11) or the tail (12) easily and securely. The embodiment is only an exemplary that is not to limit the scope of this invention.

Accordingly, the present invention obviously achieves utility and improvement and should be allowed for patent.

What is claimed is:

1. A decorative lamp-tree including a pine-like assembly and a decorative light bulb string, wherein the pine-like assembly being composed of a trunk, many branches connected with the trunk, and many tails connected with each of the branch; the light bulb string including several branch strings and several extended strings connected with each of the branch string, and the light bulb string being winded around the lamp-tree, while a branch string being relatively winded on a branch and each extended string being winded around a tail of the branch.
